(19) United States
(12) Patent Application Publication
(10) Pub. No.: US 2012/0140255 A1
(43) Pub. Date: Jun. 7, 2012

(54) APPLICATION LAUNCHER APPARATUS

(75) Inventor: Shun TANAKA, West Caldwell, NJ (US)

(73) Assignee: RICOH COMPANY, LTD., Tokyo (JP)

(21) Appl. No.: 12/958,686

(22) Filed: Dec. 2, 2010

(51) Int. Cl. G06F 3/12

(52) U.S. Cl. 358/1.13

(57) ABSTRACT

Apparatuses, systems and methods are provided for managing application functionalities of a multi-function apparatus.

### TECHNICAL FIELD

This disclosure relates to systems, apparatuses and methodologies for managing application functionalities of a multi-function apparatus.

### BACKGROUND

In the current information age, information technology (IT) tools such as multi-function apparatuses are extensively used in enterprises and other organizations in order manage and exchange documents and other electronic data.

A typical multi-function apparatus may include a plurality of application functionalities that provide useful services over a network for various users. For example, the multi-function apparatus may include a document processing/editing function, an internet browser function, an email function, a network copier function, a network scanning function, a facsimile function, and other similar functions.

There is a drawback, however, in that a user interface of many multi-function apparatuses is often complicated and difficult to use as a practical matter. In particular, if a large number of application functionalities are installed onto the multi-function apparatus over a period of time, the conventional user interface may not appear seamless but instead may become cluttered with an overwhelming number of options. As a result, the interface of the multi-function apparatus is not user-friendly.

There exists a need for an improved system for managing application functionalities of a multi-function apparatus, which is not as difficult and time-consuming to use.

### SUMMARY

This disclosure describes various tools (such as systems, apparatuses, methodologies, computer program products, etc.) for managing a plurality of application functionalities of a multi-function apparatus.

In an aspect of this disclosure, there is provided a system or an apparatus including a user interface control part that generates (and causes to be displayed on a display unit) user-selectable icons corresponding to a plurality of applications, and controls a visual configuration of the icons, based on usage history information. A usage history maintenance part may also be provided to maintain usage history information indicating a usage history of each of the applications.

In another aspect, a position of one or more of the icons displayed on the display unit is controlled, based on the usage history information.

In another aspect, a size of one or more of the icons displayed on the display unit is controlled, based on the usage history information.

In another aspect, a brightness of one or more of the icons displayed on the display unit is controlled, based on the usage history information.

In another aspect, an order of arrangement of the icons is controlled, based on the usage history information.

In another aspect, an order of sizing of the icons is controlled, based on the usage history information.

In another aspect, an order of brightness of the icons is controlled, based on the usage history information.

In another aspect, the usage history information indicates a selection frequency of each of the icons.

In another aspect, if the usage history information indicates that a first application has been accessed less than a predetermined number of times, then the user interface control part hides a first icon corresponding to the first application.

In another aspect of this disclosure, a first multi-function apparatus is connected to a second multi-function apparatus via a network, and the usage history maintenance part of the first multi-function apparatus maintains usage history information based on global usage information received from the second multi-function apparatus.

### BRIEF DESCRIPTION OF THE DRAWINGS

The aforementioned and other features, aspects and advantages can be more readily understood from the following detailed description with reference to the accompanying drawings wherein:

FIGS. 1A and 1B show block diagrams of a system, according to an exemplary embodiment of this disclosure;

FIG. 2 shows an example of usage history information;

FIG. 3 shows an example of a user interface display screen of a multi-function apparatus;

FIG. 4 shows an example of a user interface display screen of a multi-function apparatus, according to an exemplary embodiment of this disclosure;

FIG. 5 shows an example of a user interface display screen of a multi-function apparatus, according to an exemplary embodiment of this disclosure;

FIG. 6 shows an example of a workflow on an application launcher apparatus side;

FIG. 7 shows an example of a more detailed workflow on an application launcher apparatus side, according to an exemplary embodiment of this disclosure;

FIG. 8 shows an example of a more detailed workflow on an application launcher apparatus side, according to an exemplary embodiment of this disclosure;

FIG. 9 shows an example of a user interface display screen of a multi-function apparatus, according to an exemplary embodiment of this disclosure;

FIG. 10 shows an example of a user interface display screen of a multi-function apparatus, according to an exemplary embodiment of this disclosure;

FIG. 11 shows an example of a more detailed workflow on an application launcher apparatus side, according to an exemplary embodiment of this disclosure;

FIG. 12 shows an example of a more detailed workflow on an application launcher apparatus side, according to an exemplary embodiment of this disclosure;

FIG. 13 shows an example of a user interface display screen of a multi-function apparatus, according to an exemplary embodiment of this disclosure;

FIG. 14 shows an example of a user interface display screen of a multi-function apparatus, according to an exemplary embodiment of this disclosure;

FIG. 15 shows an example of a more detailed workflow on an application launcher apparatus side, according to an exemplary embodiment of this disclosure;

FIG. 16 shows an example of a more detailed workflow on an application launcher apparatus side, according to an exemplary embodiment of this disclosure;

FIGS. 17A and 17b show examples of user interface display screens of a multi-function apparatus, according to an exemplary embodiment of this disclosure;

FIG. 18 shows an example of a more detailed workflow on an application launcher apparatus side, according to an exemplary embodiment of this disclosure;

FIG. 19 shows a block diagram of a system, according to an exemplary embodiment of this disclosure;

FIG. 20 shows a block diagram of an exemplary configuration of a multi-function apparatus.

### DETAILED DESCRIPTION

In describing preferred embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner. In addition, a detailed description of known functions and configurations will be omitted when it may obscure the subject matter of the present invention.

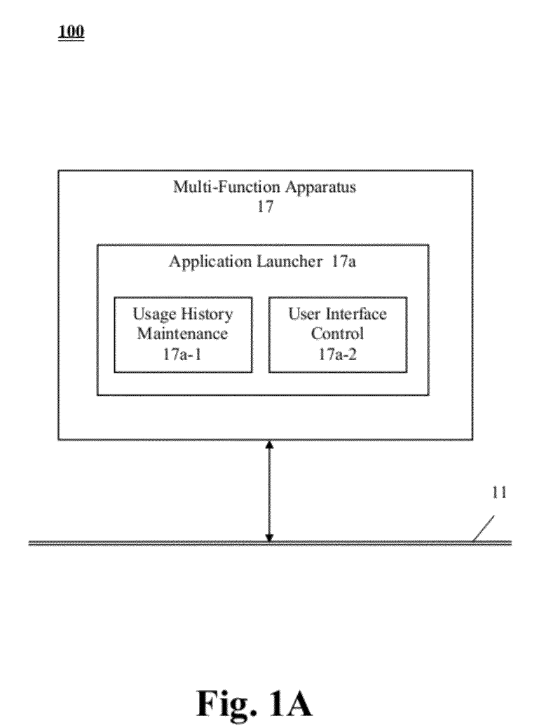

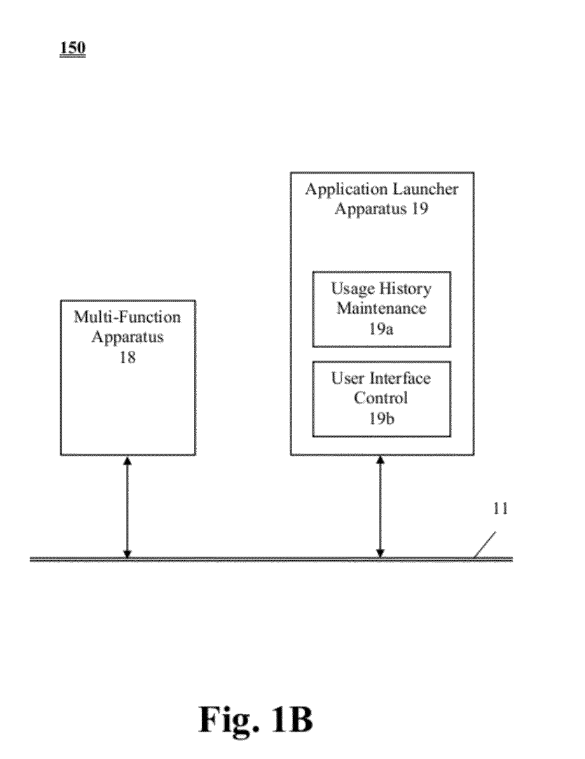

Referring now to the drawings, wherein like reference numerals designate identical or corresponding parts throughout the several views, FIG. 1A shows schematically a system 100 for managing a plurality of application functionalities of a multi-function apparatus, according to an exemplary embodiment of this disclosure.

System 100 includes a multi-function apparatus 17 connected to a network 11.

The multi-function apparatus 17 may be a client terminal or any computing device including but not limited to a personal, notebook or workstation computer, a kiosk, a PDA (personal digital assistant), a scanner, a printer, a facsimile machine, a general MFD (multi-function apparatus), a server, a mobile phone or handset, another information terminal, etc. The multi-function apparatus 17 is configured with software allowing the multi-function apparatus 17 to execute a plurality of applications (or application functionalities). Further, the multi-function apparatus 17 may transmit data to, and receive data from, other network-connected devices (not shown) connected to the network 11.

The multi-function apparatus 17 includes an application launcher part 17a. The application launcher part 17a includes a usage history maintenance part 17a-1, and a user interface control part 17a-2.

The application launcher part 17a of the multi-function apparatus 17 may be hardware or software installed on the multi-function apparatus 17 in order to realize certain aspects of this disclosure as described further below. (Alternatively, note that the application launcher part 17a may instead be embodied as an application launcher apparatus separate from multi-function device 17. For example, FIG. 1B depicts a system 150 where a multi-function device 18 and application launcher apparatus 19 are interconnected via network 11. The application launcher apparatus 19 is similar to the application launcher part 17a of FIG. 1A, and includes a usage history maintenance part 19a and user interface control part 19b, which are similar to usage history maintenance part 17a-1 and user interface control part 17a-2, respectively).

The usage history maintenance part 17a-1 is configured to maintain usage history information indicating a usage history of each of the applications that may be executed on the multi-function apparatus 17. That is, the usage history information indicates the number of times each application has been accessed or used over a certain period of time. The usage history may be determined by keeping a record of how many times the application itself has been accessed, or by recording the selection frequency of a user-selectable icon corresponding to the application (e.g. how many times users have touched an icon corresponding to the application on a touch screen of the multi-function device).

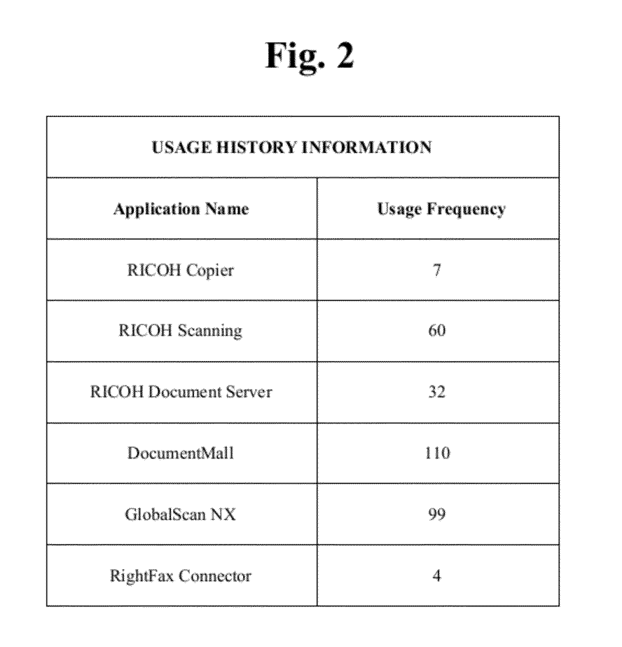

An example of usage history information maintained by the usage history maintenance part is depicted in FIG. 2. The usage history information includes an application name that identifies the applications operating on the multi-function apparatus 17, such as “RICOH Copier”, “RIOCH Scanning” and so forth. The usage history information also includes the usage frequency of each application. In the example of FIG. 2 it will be seen that the application RICOH Copier has been accessed 7 times, the application RICOH Scanning has been accessed 60 times, and so on. Thus, the usage history information maintained by the usage history maintenance part 17a-1 indicates a usage history each of the plurality of applications operating on the multi-function apparatus 17.

The user interface control part 17a-2 is configured to generate a plurality of user-selectable icons corresponding to the plurality of applications operating on the multi-function apparatus 17. Further, the user interface control part is configured to display the plurality of user-selectable icons corresponding to the plurality of applications, on a display unit of the multi-function apparatus.

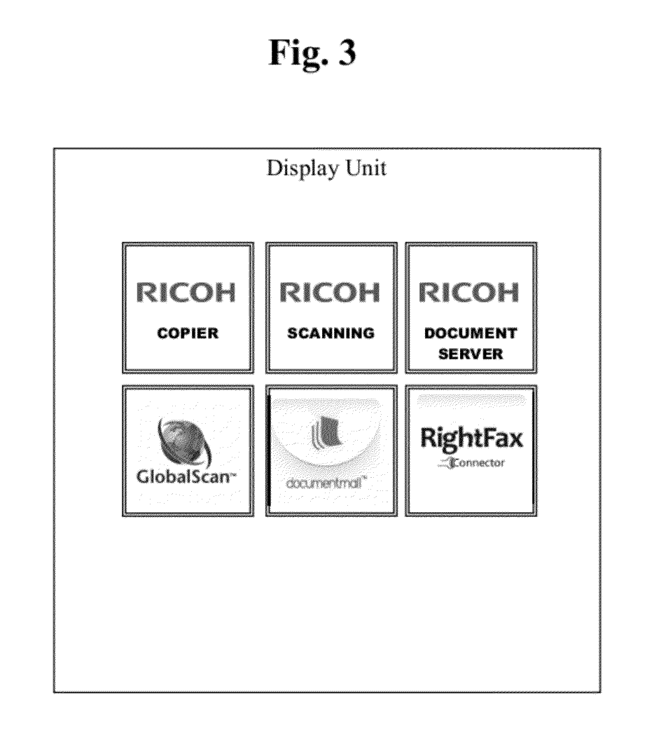

FIG. 3 depicts an example of a plurality of user-selectable icons being displayed on a display unit of the multi-function apparatus 17. In the example of FIG. 3, the user-selectable icons are identified by labels as “RICOH Copier”, “RICOH Scanning”, “RICOH Document Server, “Global Scan”, “documentmall” and “RightFax Connector.” This plurality of user-selectable icons corresponds to the plurality of applications operating on the multi-function apparatus 17 (and which are identified in the usage history information depicted in FIG. 2). The icons need not include only written labels, but may also include ornamental designs, figures, logos, and other visual features for identifying the corresponding application to the user.

The display unit of the multi-function apparatus may be, for example, a display screen, a computer monitor screen, a touch screen, etc. If the display unit is a touch screen, then the user-selectable icons may be selected by the user when the user physically touches the corresponding icon on the touch screen, in order to thereby cause the multi-function apparatus to access that application and perform some application functionality. (Note that in the embodiment of FIG. 1B, the icons may in addition, or instead, be displayed on a display unit of the application launcher apparatus 19).

The user interface control part 17a-2 controls a visual configuration of the plurality of user-selectable icons displayed on the display unit of the multi-function apparatus 17, based on the usage history information maintained by the usage history maintenance part 17a-1.

The visual configuration of the plurality of icons, as described in the disclosure, refers to any aspect of the visual or physical appearance of the plurality of icons. For example, the visual configuration of the icons may refer to the positions of each of the icons, the size of each of the icons, the brightness of each of the icons, the color of each icons, the presence of each of the icons (i.e. whether some are viewable or hidden), and any other visual aspect of the icons.

According to an exemplary embodiment of this disclosure, the user interface control part 17a-2 controls a visual configuration of the icons by controlling the position of each of the icons, based on the usage history information maintained by the usage history maintenance part 17a-1. That is, depending on how often an application has been accessed (or the selection frequency of the icon corresponding to that application), the user interface control part controls the position (on the display unit of the multi-function apparatus 17) of the icon corresponding to the application.

For example, the user interface control part 17a-2 may control the position of each of the icons by changing the order of arrangement of the plurality of icons, based on the usage history information.

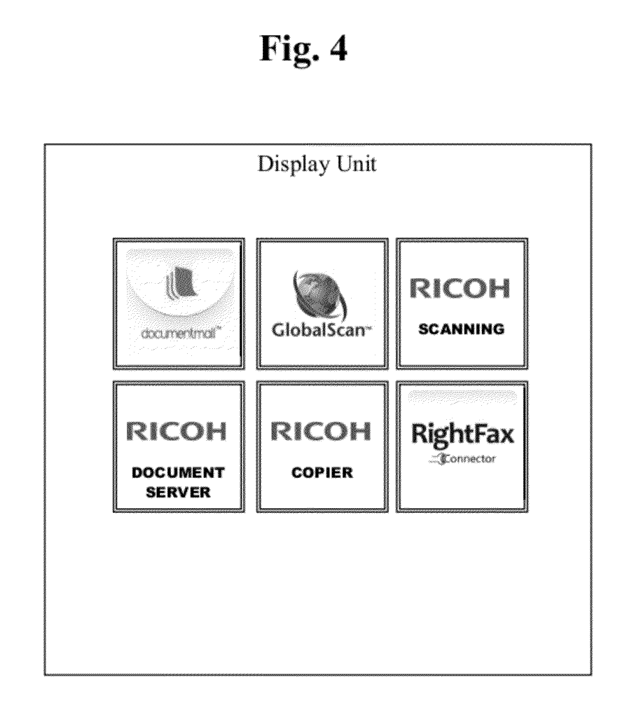

FIG. 4 depicts an example of the user interface control part 17a-2 controlling the order of arrangement of the icons (and thus the position of each one of the icons) based on the usage history information. FIG. 4 illustrates the plurality of user-selectable icons being displayed on the display unit of the multi-function apparatus 17, similar to the icons illustrated in FIG. 3, except that the order of arrangement of the icons illustrated in FIG. 4 has been controlled based on the usage history information of FIG. 2.

Based on the usage history information of FIG. 2 it can be seen that the application with the greatest usage frequency (i.e. the application accessed the most times) is DocumentMall with a usage frequency of 110, followed by GlobalScan (usage frequency: 99), RICOH Scanning (usage frequency: 60), RICOH Document Server (usage frequency: 32), RICOH Copier (usage frequency: 7) and RightFax Connector (usage frequency: 4). As a result, the order of arrangement of the icons in FIG. 4 has been changed to match the aforementioned usage frequency, from ‘most used’ to ‘least used’. That is, the order of arrangement in FIG. 4—from left to right and then from the top row to the bottom row—is now as follows: DocumentMall, GlobalScan, RICOH Scanning, RICOH Document Server, RICOH Copier, and RightFax Connector.

Note that the position of each of the icons can be continuously controlled by the user interface control part 17a-2, based on changing usage history information. If the usage history information indicates that a first application has been accessed more frequently than a second application, then an order of arrangement of the plurality of icons may be controlled by the user interface control part 17a-2, such that a first icon corresponding to the first application is arranged before a second icon corresponding to the second application in the order of arrangement.

Thus, the order of arrangement of the plurality of icons may be controlled by the user interface control part 17a-2, based on the usage history information maintained by the usage history maintenance part 17a-1. As a result, the icons are no longer arbitrarily displayed, but instead are arranged in a more meaningful and user-friendly manner. At a glance, a user is able to easily select the most popular applications that are used most often, and the user is able to see which applications have been accessed more or less times relative to other applications. This may be especially useful when the number of applications installed on a multi-function apparatus becomes very large.

While the aforementioned example refers to changing the order of arrangement of the plurality of icons, it should be understood that this exemplary embodiment encompasses any possible manner of controlling the position of each of the icons on the display unit, based on the usage history information.

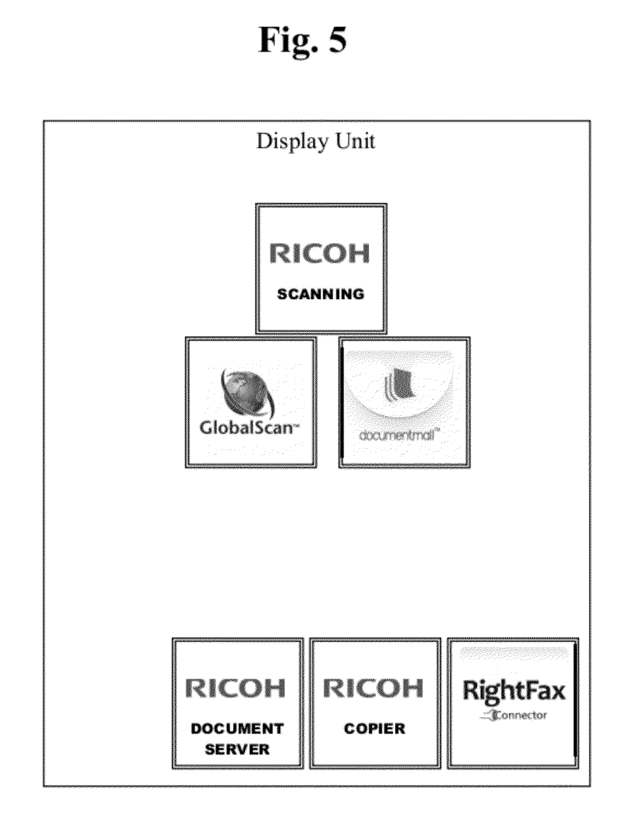

FIG. 5, for instance, displays another example of how the position of each of the icons can be controlled. In FIG. 5, the position of the icons corresponding to the applications with the greatest usage frequency (i.e. DocumentMall, GlobalScan and RICOH Scanning) has been controlled so that these icons have been moved to an upper central portion of the display screen (in no particular order). In contrast, the position of the icons corresponding to the applications with the lowest usage frequency (i.e. RICOH Document Server, RICOH Copier and RightFax Connector) has been controlled so that these icons have moved to a lower-right portion of the display screen. As a result, the icons are arranged in a user-friendly manner, and a user is able to easily select the most popular applications that are used most often. (Again, this disclosure is not limited to these examples, and encompasses any possible manner of controlling the positions of each of the icons, based on the usage history information).

Thus, according to this exemplary embodiment of this disclosure, the application launcher part 17a controls a visual configuration of the icons by controlling the position of each of the icons, based on the usage history information maintained by the usage history maintenance part. Whereas a conventional user interface of a multi-function apparatus is often complicated and difficult to use as a practical matter, the application launcher part of this exemplary embodiment allows a user to more efficiently and easily utilize the application functionalities of the multi-function apparatus 17.

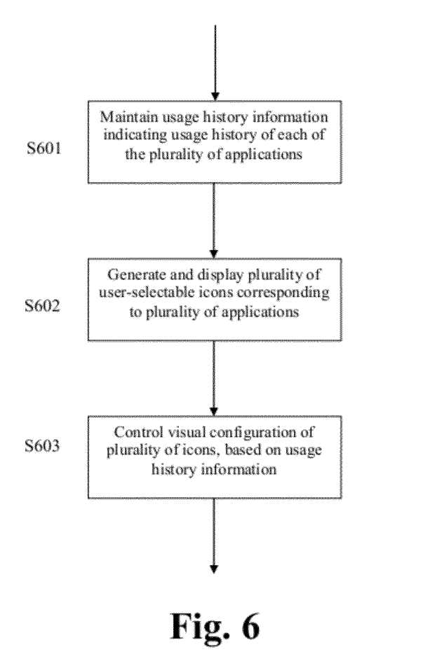

Turning now to FIG. 6, there is shown an example of a workflow on an application launcher part or an application launcher apparatus, such as the application launcher part 17a in FIG. 1A or the application launcher apparatus 19 in FIG. 1B.

In S601, the application launcher part maintains usage history information indicating a usage history of each of a plurality of applications of a multi-function apparatus. An example of usage history information is depicted in FIG. 2.

Thereafter, in S602, the application launcher part generates a plurality of user-selectable icons corresponding to the plurality of applications. The application launcher part also displays the plurality of user-selectable icons corresponding to the plurality of applications on a display unit of the multi-function apparatus. FIG. 3 depicts an example of a plurality of user-selectable icons being displayed on a display unit of a multi-function apparatus.

In S603, the application launcher part controls a visual configuration of the plurality of icons displayed on the display unit in S602, based on the usage history information maintained in S601.

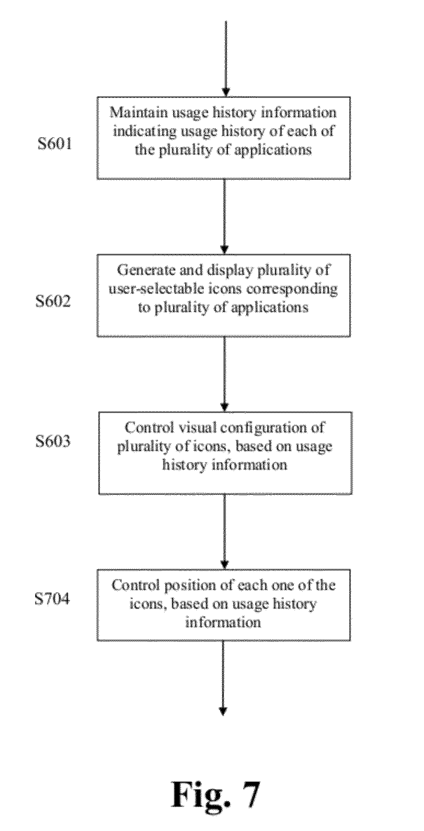

According to an exemplary embodiment of this disclosure, the application launcher part controls a visual configuration of the icons by controlling the position of each of the icons, based on the usage history information. In FIG. 7, there is shown an example of a more detailed workflow on an application launcher part (or application launcher apparatus), according to this exemplary embodiment.

Steps S601-S603 are substantially similar to S601-S603 depicted in FIG. 6.

In S704, the application launcher part controls a position of each one of the icons displayed on the display unit, based on the usage history information maintained in S601. FIG. 5, for instance, displays an example of how the position of each of the icons can be controlled, based on the usage history information illustrated in FIG. 2. In FIG. 5, the position of the icons corresponding to the applications with the greatest usage frequency (i.e. DocumentMall, GlobalScan and RICOH Scanning) has been controlled so that these icons have been moved to an upper central portion of the display screen (in no particular order). In contrast, the position of the icons corresponding to the applications with the lowest usage frequency (i.e. RICOH Document Server, RICOH Copier and RightFax Connector) has been controlled so that these icons have moved to a lower-right portion of the display screen.

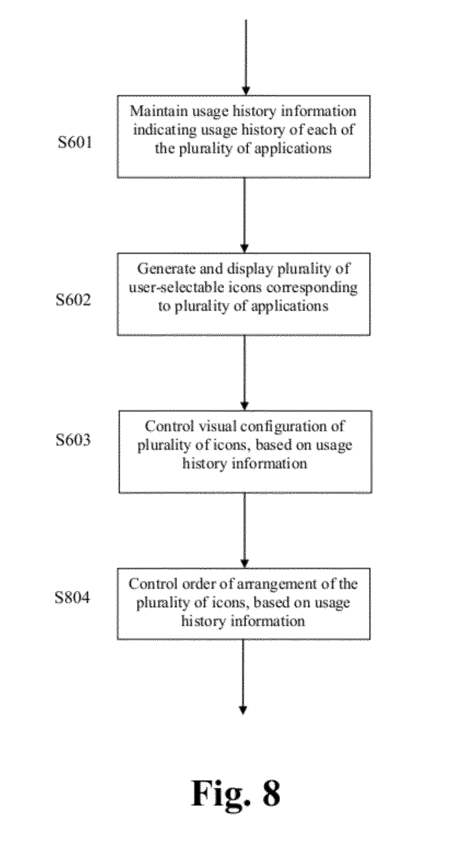

In FIG. 8, there is shown another example of a detailed workflow on an application launcher part (or application launcher apparatus), according to this exemplary embodiment.

Steps S601-S603 are substantially similar to S601-S603 depicted in FIG. 6.

In S804, the application launcher part controls an order of arrangement of the plurality of icons displayed on the display unit, based on the usage history information maintained in S601. FIG. 4 depicts an example of the application launcher part controlling the order of arrangement of the icons, based on the usage history information illustrated in FIG. 2. That is, the order of arrangement of the icons in FIG. 4—from left to right and then from the top row to the bottom row—tracks the usage frequency (from highest to lowest) illustrated in FIG. 2.

According to another exemplary embodiment of this disclosure, the user interface control part 17a-2 controls a visual configuration of the icons by controlling the size of each of the icons, based on the usage history information maintained by the usage history maintenance part 17a-1. That is, depending on how often an application has been accessed (or the selection frequency of the icon corresponding to that application), the user interface control part controls the size (on the display unit of the multi-function apparatus 17) of the icon corresponding to the application.

For example, the user interface control part 17a-2 may control the size of each of the icons by changing the order of sizing of the plurality of icons, based on the usage history information.

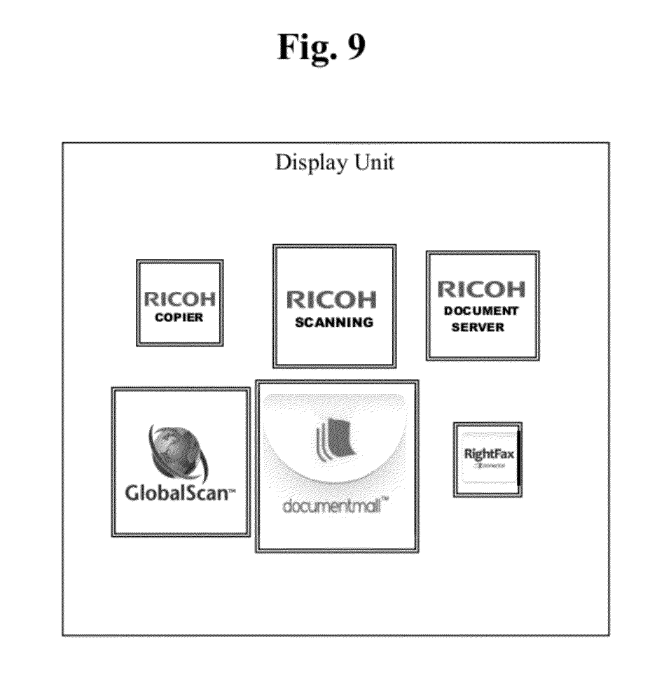

FIG. 9 depicts an example of the user interface control part 17a-2 controlling the order of sizing of the icons (and thus the size of each one of the icons) based on the usage history information. FIG. 9 illustrates the plurality of user-selectable icons being displayed on the display unit of the multi-function apparatus 17, similar to the icons illustrated in FIG. 3, except that the order of sizing of the icons illustrated in FIG. 9 has been controlled based on the usage history information of FIG. 2.

Based on the usage history information of FIG. 2 it can be seen that the application with the greatest usage frequency (i.e. the application accessed the most times) is DocumentMall with a usage frequency of 110, followed by GlobalScan (usage frequency: 99), RICOH Scanning (usage frequency: 60), RICOH Document Server (usage frequency: 32), RICOH Copier (usage frequency: 7) and RightFax Connector (usage frequency: 4). As a result, the order of sizing of the icons in FIG. 9 has been changed to match the aforementioned usage frequency, from ‘most used’ to ‘least used’. That is, the order of sizing of the icons in FIG. 9—from largest to smallest—is now as follows: DocumentMall, GlobalScan, RICOH Scanning, RICOH Document Server, RICOH Copier, and RightFax Connector.

Note that the size of each of the icons can be continuously controlled by the user interface control part 17a-2, based on changing usage history information. If the usage history information indicates that a first application has been accessed more frequently than a second application, then an order of sizing of the plurality of icons is controlled by the user interface control part, such that a first icon corresponding to the first application is larger than a second icon corresponding to the second application.

Thus, the order of sizing of the plurality of icons may be controlled by the user interface control part 17a-2, based on the usage history information maintained by the usage history maintenance part 17a-1. At a glance, a user is able to easily select the most popular applications that are used most often, and the user is able to see which applications have been accessed more or less times relative to other applications, based on the size of the icons. This may be especially useful when the number of applications installed on a multi-function apparatus becomes very large.

While the aforementioned example refers to changing the order of sizing of the plurality of icons, it should be understood that this exemplary embodiment encompasses any possible manner of controlling the size of each of the icons on the display unit, based on the usage history information.

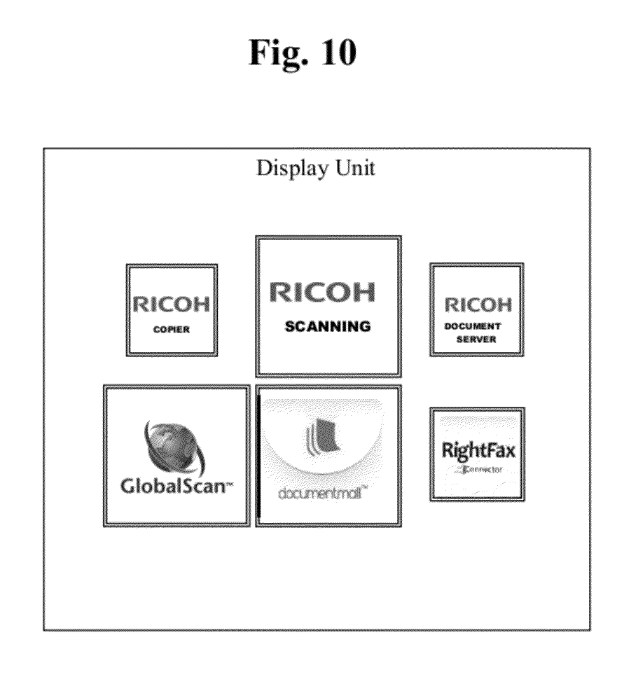

FIG. 10, for instance, displays another example of how the size of each of the icons can be controlled. In FIG. 10, the size of the icons corresponding to the applications with the greatest usage frequency (i.e. DocumentMall, GlobalScan and RICOH Scanning) has been controlled so that these icons have become larger in size on the display screen. In contrast, the size of the icons corresponding to the applications with the lowest usage frequency (i.e. RICOH Document Server, RICOH Copier and RightFax Connector) has been controlled so that these icons have become smaller in size on the display screen. As a result, the icons appear in a user-friendly manner, and a user is able to easily select the most popular applications that are used most often. (Again, this disclosure is not limited to these examples, and encompasses any possible manner of controlling the size of each of the icons, based on the usage history information).

Thus, according to this exemplary embodiment of this disclosure, the application launcher part 17a controls a visual configuration of the icons by controlling the size of each of the icons, based on the usage history information maintained by the usage history maintenance part.

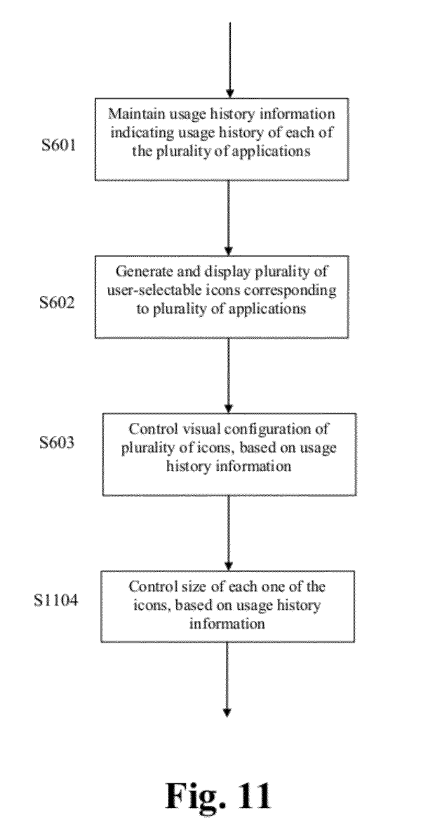

Turning now to FIG. 11, there is shown an example of a more detailed workflow on an application launcher part (or application launcher apparatus), according to this exemplary embodiment.

Steps S601-S603 are substantially similar to S601-S603 depicted in FIG. 6.

In S1104, the application launcher part controls a size of each one of the icons displayed on the display unit, based on the usage history information maintained in S601. FIG. 10, for instance, displays an example of how the size of each of the icons can be controlled, based on the usage history information illustrated in FIG. 2. In FIG. 10, the size of the icons corresponding to the applications with the greatest usage frequency (i.e. DocumentMall, GlobalScan and RICOH Scanning) has been controlled so that these icons have become larger in size.

In contrast, the size of the icons corresponding to the applications with the lowest usage frequency (i.e. RICOH Document Server, RICOH Copier and RightFax Connector) has been controlled so that these icons have become smaller in size.

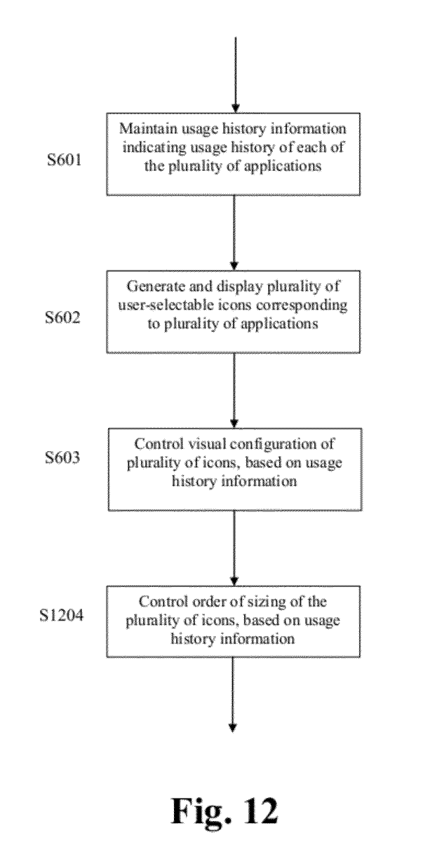

In FIG. 12, there is shown another example of a detailed workflow on an application launcher part (or application launcher apparatus), according to this exemplary embodiment.

Steps S601-S603 are substantially similar to S601-S603 depicted in FIG. 6.

In S1204, the application launcher part controls an order of sizing of the plurality of icons displayed on the display unit, based on the usage history information maintained in S601. FIG. 9 depicts an example of the application launcher part controlling the order of sizing of the icons, based on the usage history information illustrated in FIG. 2. That is, the order of sizing of the icons in FIG. 4—from largest to smallest—tracks the usage frequency (from highest to lowest) illustrated in FIG. 2.

According to another exemplary embodiment of this disclosure, the user interface control part 17a-2 controls a visual configuration of the icons by controlling the brightness of each of the icons, based on the usage history information maintained by the usage history maintenance part 17a-1. That is, depending on how often an application has been accessed (or the selection frequency of the icon corresponding to that application), the user interface control part controls the brightness (on the display unit of the multi-function apparatus 17) of the icon corresponding to the application.

For example, the user interface control part 17a-2 may control the brightness of each of the icons by changing the order of brightness of the plurality of icons, based on the usage history information.

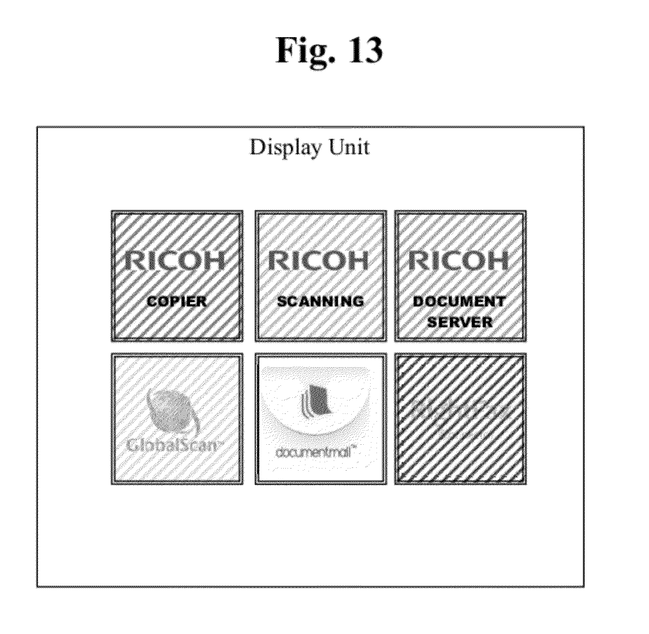

FIG. 13 depicts an example of the user interface control part 17a-2 controlling the order of brightness of the icons (and thus the brightness of each one of the icons) based on the usage history information. FIG. 13 illustrates the plurality of user-selectable icons being displayed on the display unit of the multi-function apparatus 17, similar to the icons illustrated in FIG. 3, except that the order of brightness of the icons illustrated in FIG. 13 has been controlled based on the usage history information of FIG. 2.

Based on the usage history information of FIG. 2 it can be seen that the application with the greatest usage frequency (i.e. the application accessed the most times) is DocumentMall with a usage frequency of 110, followed by GlobalScan (usage frequency: 99), RICOH Scanning (usage frequency: 60), RICOH Document Server (usage frequency: 32), RICOH Copier (usage frequency: 7) and RightFax Connector (usage frequency: 4). As a result, the order of brightness of the icons in FIG. 13 has been changed to match the aforementioned usage frequency, from ‘most used’ to ‘least used’. That is, the order of brightness of the icons in FIG. 13—from brightest to darkest—is now as follows: DocumentMall, GlobalScan, RICOH Scanning, RICOH Document Server, RICOH Copier, and RightFax Connector.

Note that the brightness of each of the icons can be continuously controlled by the user interface control part 17a-2, based on changing usage history information. If the usage history information indicates that a first application has been accessed more frequently than a second application, then an order of brightness of the plurality of icons is controlled by the user interface control part, such that a first icon corresponding to the first application is brighter than a second icon corresponding to the second application.

Thus, the order of brightness of the plurality of icons may be controlled by the user interface control part 17a-2, based on the usage history information maintained by the usage history maintenance part 17a-1. At a glance, a user is able to easily select the most popular applications that are used most often, and the user is able to see which applications have been accessed more or less times relative to other applications, based on the brightness of the icons. This may be especially useful when the number of applications installed on a multi-function apparatus becomes very large.

While the aforementioned example refers to changing the order of brightness of the plurality of icons, it should be understood that this exemplary embodiment encompasses any possible manner of controlling the brightness of each of the icons on the display unit, based on the usage history information.

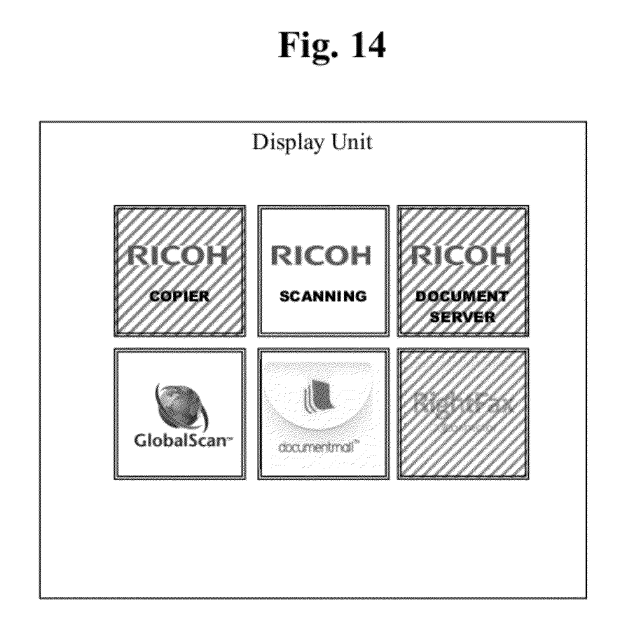

FIG. 14, for instance, displays another example of how the brightness of each of the icons can be controlled. In FIG. 14, the brightness of the icons corresponding to the applications with the greatest usage frequency (i.e. DocumentMall, GlobalScan and RICOH Scanning) has been controlled so that these icons appear brighter on the display screen. In contrast, the brightness of the icons corresponding to the applications with the lowest usage frequency (i.e. RICOH Document Server, RICOH Copier and RightFax Connector) has been controlled so that these icons appear darker on the display screen. As a result, the icons appear in a user-friendly manner, and a user is able to easily select the most popular applications that are used most often. (Again, this disclosure is not limited to these examples, and encompasses any possible manner of controlling the brightness of each of the icons, based on the usage history information).

Thus, according to this exemplary embodiment of this disclosure, the application launcher part 17a controls a visual configuration of the icons by controlling the brightness of each of the icons, based on the usage history information maintained by the usage history maintenance part.

This exemplary embodiment could also be applied to controlling the color of each of the icons in a similar manner, based on usage history information. For example, icons with a higher usage frequency could be controlled to be a darker/strong variant of a color, while icons with a lower usage frequency could be controlled to be a lighter/weaker variant of the same color, or vice versa. As another example, icons with a higher usage frequency could be controlled to be a first color, while icons with a lower usage frequency could be controlled to be a second color, and so forth.

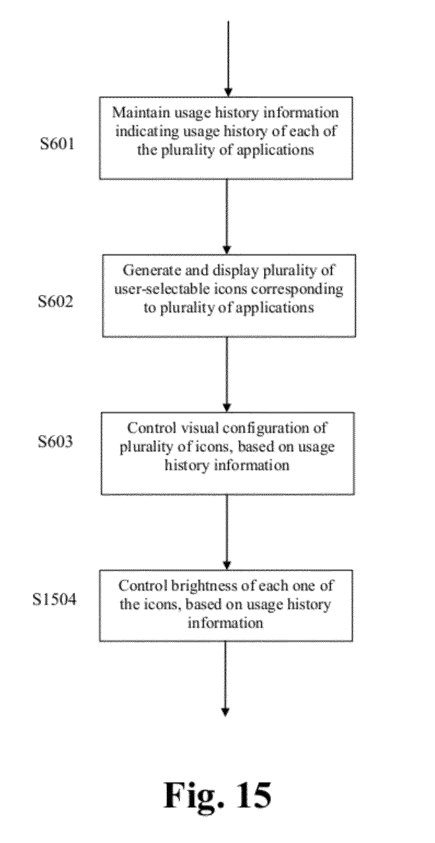

Turning now to FIG. 15, there is shown an example of a more detailed workflow on an application launcher part (or application launcher apparatus), according to this exemplary embodiment.

Steps S601-S603 are substantially similar to S601-S603 depicted in FIG. 6.

In S1504, the application launcher part controls a brightness of each one of the icons displayed on the display unit, based on the usage history information maintained in S601. FIG. 14, for instance, displays an example of how the brightness of each of the icons can be controlled, based on the usage history information illustrated in FIG. 2. In FIG. 14, the brightness of the icons corresponding to the applications with the greatest usage frequency (i.e. DocumentMall, GlobalScan and RICOH Scanning) has been controlled so that these icons appear brighter. In contrast, the brightness of the icons corresponding to the applications with the lowest usage frequency (i.e. RICOH Document Server, RICOH Copier and RightFax Connector) has been controlled so that these icons appear darker.

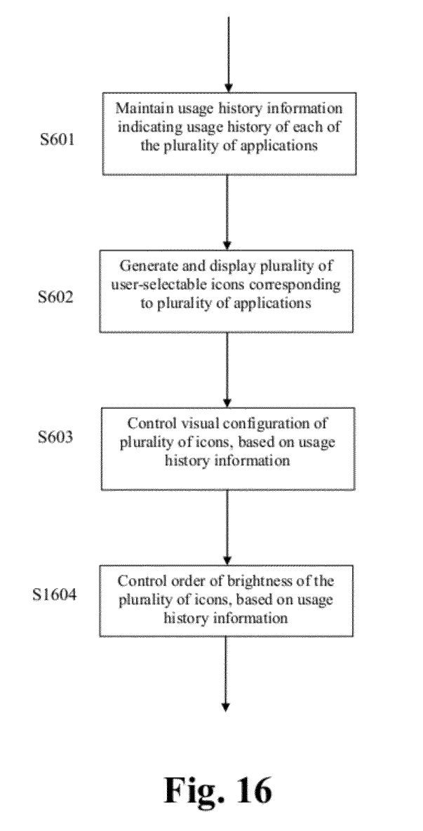

In FIG. 16, there is shown another example of a detailed workflow on an application launcher part (or application launcher apparatus), according to this exemplary embodiment.

Steps S601-S603 are substantially similar to S601-S603 depicted in FIG. 6.

In S1604, the application launcher part controls an order of brightness of the plurality of icons displayed on the display unit, based on the usage history information maintained in S601. FIG. 13 depicts an example of the application launcher part controlling the order of brightness of the icons, based on the usage history information illustrated in FIG. 2. That is, the order of brightness of the icons in FIG. 4—from brightest to darkest—tracks the usage frequency (from highest to lowest) illustrated in FIG. 2.

According to another exemplary embodiment of this disclosure, the user interface control part 17a-2 controls a visual configuration of the icons by controlling the presence of each of the icons, based on the usage history information maintained by the usage history maintenance part 17a-1. That is, depending on how often an application has been accessed (or the selection frequency of the icon corresponding to that application), the user interface control part may hide (on the display unit of the multi-function apparatus 17) the icon corresponding to the application.

For example, if the usage history information indicates that a first application has been accessed less than a predetermined number of times, the user interface control part 17a-2 may hide a first icon corresponding to the first application.

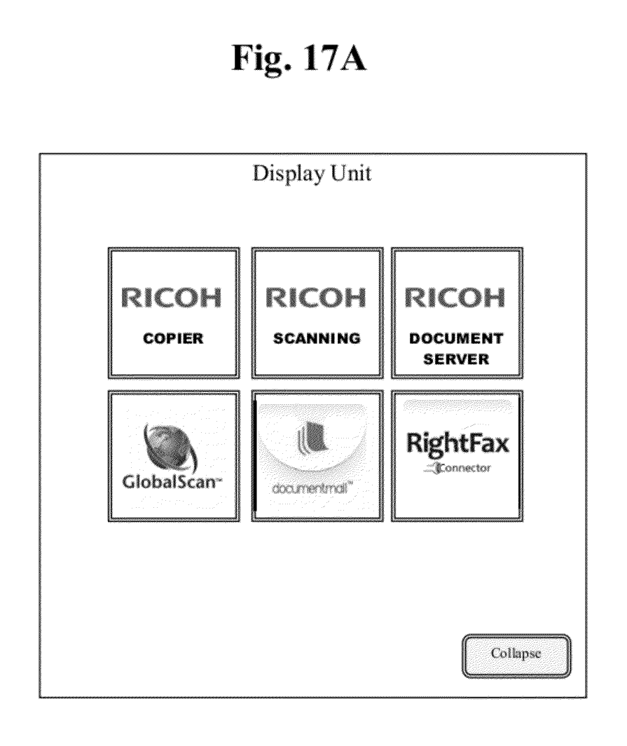

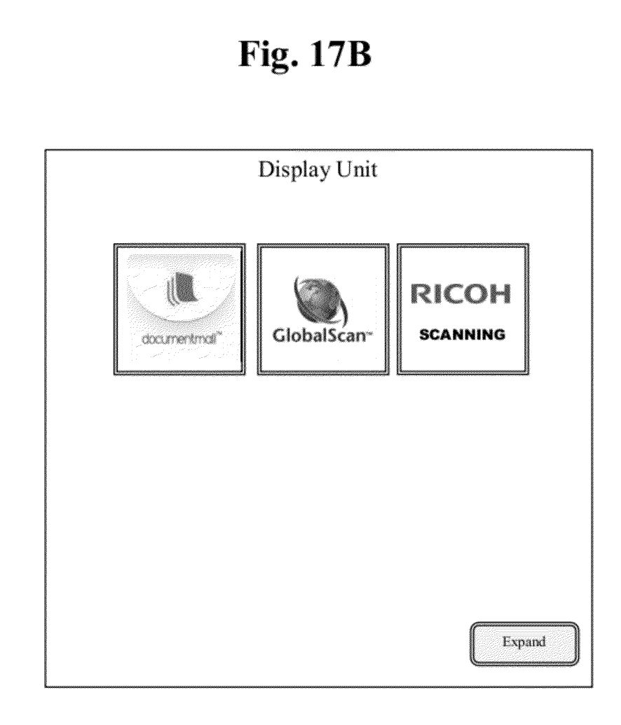

FIGS. 17A and 17B depicts an example of the user interface control part 17a-2 hiding icons that have been accessed less than a predetermined number of times (in this case, 50 times) based on the usage history information depicted in FIG. 2. FIG. 17A illustrates a plurality of user-selectable icons being displayed on the display unit of the multi-function apparatus 17, similar to the icons illustrated in FIG. 3. Also depicted on the display screen is a ‘Collapse’ button that causes the user interface control part 17a-2 to hide icons that have been accessed less than the predetermined number of times.

FIG. 17B depicts the result when the ‘Collapse’ button is selected by the user. Based on the usage history information of FIG. 2, it is determined that the applications with a usage frequency of less than 50 are RICOH Document Server (usage frequency: 32), RICOH Copier (usage frequency: 7) and RightFax Connector (usage frequency: 4). Accordingly, the icons corresponding to these applications have been hidden, as depicted in FIG. 17B. By pressing the ‘Expand’ button on the screen illustrated in FIG. 17B, the hidden icons can reappear and the display unit of the multi-function apparatus returns to the screen illustrated FIG. 17A.

Thus, the presence of the plurality of icons may be controlled by the user interface control part 17a-2, based on the usage history information maintained by the usage history maintenance part 17a-1. At a glance, a user is only presented with the most popular applications that are used most often.

This may be especially useful when the number of applications installed on a multi-function apparatus becomes very large.

While the aforementioned example refers to hiding icons based on a predetermined number, it should be understood that this exemplary embodiment encompasses any possible manner of controlling the presence of each of the icons on the display unit, based on the usage history information.

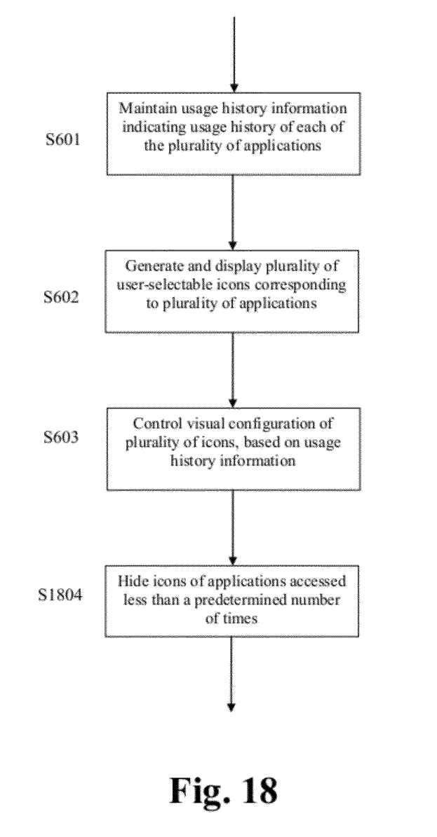

Turning now to FIG. 18, there is shown an example of a more detailed workflow on an application launcher part (or application launcher apparatus), according to this exemplary embodiment.

Steps S601-S603 are substantially similar to S601-S603 depicted in FIG. 6.

In S1804, the application launcher part hides icons that have been accessed less than a predetermined number of times, based on the usage history information maintained in S601. FIGS. 17A and 17B depicts an example of the user interface control part 17a-2 hiding icons that have been accessed less than a predetermined number of times (in this case, 50) based on the usage history information depicted in FIG. 2.

While the example shown in FIGS. 1A and 1B includes one multi-function apparatus, it should be appreciated that such numbers of devices is are arbitrary and are selected as an example in order to facilitate discussion, and that the subject matter of this disclosure can be implemented in a system including one or more systems, servers, apparatuses and terminals. Other devices, such as scanners, printers and multi-function devices (MFDs) may also be connected to the network 11, as is well known in the art.

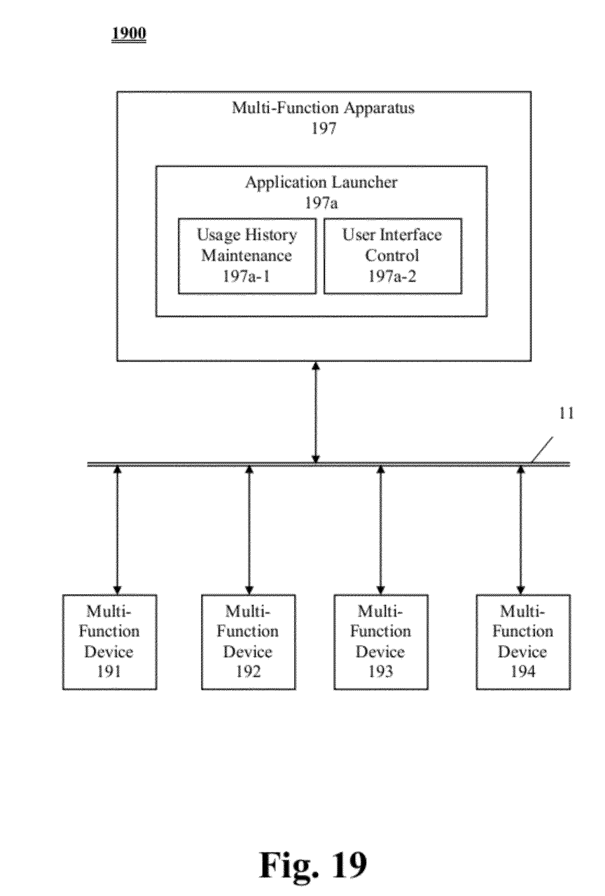

For example, in FIG. 19 there is shown schematically a system 1900 for managing a plurality of multi-function apparatuses, according to another exemplary embodiment of this disclosure.

System 1900 is similar to system 100 depicted in FIG. 1A, except that system 1900 includes a plurality of multi-function apparatuses 191 through 194, as well as multi-function apparatus 197, all interconnected via network 11.

The multi-function apparatus 197 may be substantially similar to the multi-function apparatus 17 depicted in FIG. 1A, and includes an application launcher part 197a comprising a usage history maintenance part 197a-1 and a user interface control part 197a-2. The plurality of multi-function apparatuses 191-194 may also be similar to the multi-function apparatus 17 depicted in FIG. 1A.

According to this exemplary embodiment, the usage history maintenance part 197a-1 of the multi-function apparatus 197 maintains the usage history information based on global usage information received from the plurality of multi-function apparatuses 191-194. That is, each of the multi-function apparatuses 191 through 194 may generate local usage history information (based on how many times a plurality of applications have been accessed locally on each apparatus), as described in this disclosure. Thereafter, this local usage history information from each apparatus is collected to generate global usage history information (indicated the usage frequency of the plurality of applications on all the multi-function apparatuses). The global usage history is then transmitted to the multi-function apparatus 197 and the rest of the plurality of multi-function apparatuses 191-194. In this way, the user interface control part 197a-2 of the multi-function apparatus 197 may control the visual configuration of icons on a display unit of the multi-function apparatus 197, based on the global usage history information.

According to another exemplary embodiment, the user interface control part 197a-2 controls the visual configuration of a plurality of icons being displayed on a display unit of at least one of the apparatuses 191-194. This may be done based on global usage history information or local usage history information local to any one of the apparatuses 191-194 and 197. Further, the visual configuration of the plurality of icons displayed on the display unit of the multifunction apparatus 197 itself, may be exported to at least one of the apparatuses 191-194.

While the example shown in FIGS. 1A, 1B and 19 depicts the multi-function apparatuses as being connected to a single network, the subject matter of this disclosure can be implemented in a system with different network arrangements.

Each multi-function apparatus can be any computing device, including but not limited to a personal, notebook or workstation computer, a kiosk, a PDA (personal digital assistant), a MFD (multi-function device), a server, a mobile phone or handset, another information terminal, etc., that can communicate through the network 11 with other devices.

The multi-function apparatus can be configured in software or hosted on any computing device, including but not limited to a personal, notebook or workstation computer, a kiosk, a PDA (personal digital assistant), a MFD, a server, a mobile phone or handset, another information terminal, etc., that can communicate through the network 11 with other devices.

The application launcher part and/or application launcher apparatus of this disclosure may be realized by a computer program product including a computer-usable, non-transient medium (such as a disk storage apparatus) having instructions tangibly embodied therein that are executed by a computer.

Thus, it should be understood that the application launcher part/apparatus may be executed on a computer.

The multi-function may include a data store that can comprise one or more structural or functional parts that have or support a storage function. For example, the data store can be, or can be a component of, a source of electronic data, such as a document access apparatus, a backend server connected to a document access apparatus, an e-mail server, a file server, a multi-function peripheral device (MFP or MFD), a voice data server, an application server, a computer, a network apparatus, a terminal etc. It should be appreciated that the term “electronic document” or “electronic data”, as used herein, in its broadest sense, can comprise any data that a user may wish to access, retrieve, review, etc.

The network 11 can include one or more of a secure intranet or extranet local area network, a wide area network, any type of network that allows secure access, etc., or a combination thereof. Further, other secure communications links (such as a virtual private network, a wireless link, etc.) may be used as well in the network 11. In addition, the network 11 preferably uses TCP/IP (Transmission Control Protocol/Internet Protocol), but other protocols can also be used. How devices can connect to and communicate over the network 31 is well-known in the art and is discussed for example, in “How Networks Work”, by Frank J. Derfler, Jr. and Les Freed (Que Corporation 2000) and “How Computers Work”, by Ron White, (Que Corporation 1999), the entire contents of each of which are incorporated herein by reference.

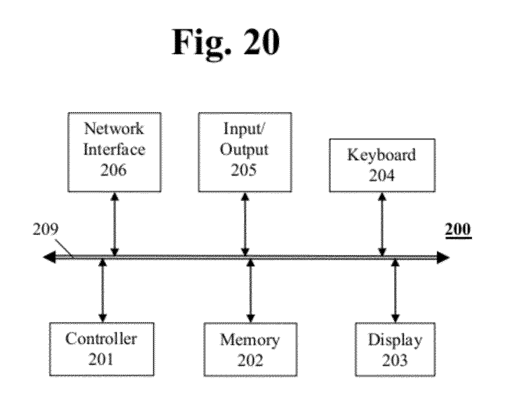

An example of a configuration of the multi-function apparatus 17 (for example, as a computer) is shown schematically in FIG. 20. In FIG. 20, computer 200 includes a controller (or central processing unit) 201 that communicates with a number of other components, including memory 202, display 203, keyboard (and/or keypad) 204, other input/output (such as mouse, touchpad, stylus, microphone and/or speaker with voice/speech interface and/or recognition software, etc.) 205, and network interface 206, by way of internal bus 209.

The multi-function apparatus 200 may be a special-purpose device (such as including one or more application specific integrated circuits or an appropriate network of conventional component circuits) or it may be software-configured on a conventional personal computer or computer workstation with sufficient memory, processing and communication capabilities to operate as a terminal and/or server, as will be appreciated to those skilled in the relevant arts.

In multi-function apparatus 200, the controller 201 executes program code instructions that control device operations. The controller 201, memory/storage 202, network interface 206, display 203 and keyboard 204 are conventional, and therefore in order to avoid occluding the inventive aspects of this disclosure, such conventional aspects will not be discussed in detail herein.

The memory 202 can provide storage for program and data, and may include a combination of assorted conventional storage devices such as buffers, registers and memories [for example, read-only memory (ROM), programmable ROM (PROM), erasable PROM (EPROM), electrically erasable PROM (EEPROM), static random access memory (SRAM), dynamic random access memory (DRAM), non-volatile random access memory (NOVRAM), etc.].

The network interface 206 provides a connection (for example, by way of an Ethernet connection or other network connection which supports any desired network protocol such as, but not limited to TCP/IP, IPX, IPX/SPX, or NetBEUI) to network 11.

A user interface may be provided and is configured through software natively or received through a network connection, to allow the user to access electronic data or content on the network-connected apparatus and/or via the network, interact with network-connected apparatuses and services, enjoy other software-driven functionalities, etc. For example, a browser (such as Internet Explorer™, Netscape Navigator™, a proprietary browser, etc.) may be provided on the client terminal so that a user of the client terminal can use browsing operations to communicate with network-connected devices, and access other data or content.

Thus, one or more of the user interfaces (such as the user interface of the multi-function apparatus 17) may be provided as web services through the network to a client terminal.

Additional aspects or components of the computer 200 are conventional (unless otherwise discussed herein), and in the interest of clarity and brevity are not discussed in detail herein. Such aspects and components are discussed, for example, in “How Computers Work”, by Ron White (Que Corporation 1999), and “How Networks Work”, by Frank J. Derfler, Jr. and Les Freed (Que Corporation 2000), the entire contents of each of which are incorporated herein by reference.

As mentioned above, multi-function apparatus 17 is not limited to a personal computer, but can be manifested in a form of any of various devices that can be configured to communicate over a network and/or the Internet.

The above-mentioned specific embodiments are illustrative, and many variations can be introduced on these embodiments without departing from the spirit of the disclosure or from the scope of the appended claims. For example, elements and/or features of different examples and illustrative embodiments may be combined with each other and/or substituted for each other within the scope of this disclosure and appended claims.

What is claimed is:

1. An application launcher apparatus for managing a plurality of applications of a multi-function apparatus, said application launcher apparatus comprising:
a usage history maintaining part configured to maintain usage history information indicating a usage history of each of said plurality of applications; and
a user interface control part configured to
generate and display a plurality of user-selectable icons corresponding to the plurality of applications on a display unit of the multi-function apparatus, and
control a visual configuration of the plurality of icons displayed on the display unit, based on the usage history information.

2. The application launcher apparatus of claim 1, wherein a position of each one of the icons displayed on the display unit is controlled by the user interface control part, based on the usage history information.

3. The application launcher apparatus of claim 1, wherein a size of each one of the icons displayed on the display unit is controlled by the user interface control part, based on the usage history information.

4. The application launcher apparatus of claim 1, wherein a brightness of each one of the icons displayed on the display unit is controlled by the user interface control part, based on the usage history information.

5. The application launcher apparatus of claim 1, wherein an order of arrangement of the plurality of icons is controlled by the user interface control part, based on the usage history information.

6. The application launcher apparatus of claim 1, wherein an order of sizing of the plurality of icons is controlled by the user interface control part, based on the usage history information.

7. The application launcher apparatus of claim 1, wherein an order of brightness of the plurality of icons is controlled by the user interface control part, based on the usage history information.

8. The application launcher apparatus of claim 1, wherein if the usage history information indicates that a first application has been accessed more frequently than a second application, then an order of arrangement of the plurality of icons is controlled by the user interface control part, such that a first icon corresponding to the first application is arranged before a second icon corresponding to the second application in the order of arrangement.

9. The application launcher apparatus of claim 1, wherein if the usage history information indicates that a first application has been accessed more frequently than a second application, then an order of sizing of the plurality of icons is controlled by the user interface control part, such that a first icon corresponding to the first application is larger than a second icon corresponding to the second application.

10. The application launcher apparatus of claim 1, wherein if the usage history information indicates that a first application has been accessed more frequently than a second application, then an order of brightness of the plurality of icons is controlled by the user interface control part, such that a first icon corresponding to the first application is brighter than a second icon corresponding to the second application.

11. The application launcher apparatus of claim 1, wherein the usage history information indicates a selection frequency of each of said plurality of icons.

12. A method for managing a plurality of applications of a multi-function apparatus, by an application launcher apparatus, said method comprising:
maintaining usage history information indicating a usage history of each of the plurality of applications;
generating, and causing to be displayed on a display unit of the multi-function apparatus, a plurality of user-selectable icons corresponding to the plurality of applications; and
controlling a visual configuration of the plurality of icons, based on the usage history information.

13. The method of claim 12, further comprising:
controlling a position of each one of the icons displayed on the display unit, based on the usage history information.

14. The method of claim 12, further comprising:
controlling an order of arrangement of the plurality of icons displayed on the display unit, based on the usage history information.

15. The method of claim 12, further comprising:
controlling a size of each one of the icons displayed on the display unit, based on the usage history information.

16. The method of claim 12, further comprising:
controlling a brightness of each one of the icons displayed on the display unit, based on the usage history information.

17. A multi-function apparatus having a plurality of application functionalities and an application launcher part for managing the plurality of application functionalities, the application launcher part comprising:
a usage history maintenance part configured to maintain usage history information indicating a usage history of each of said plurality of application functionalities; and
a user interface control part configured to
generate and display a plurality of user-selectable icons corresponding to the plurality of application functionalities on a display unit of the multi-function apparatus, and
control a visual configuration of the plurality of icons, based on the usage history information.

18. The multi-function apparatus of claim 17, wherein if the usage history information indicates that a first application has been accessed less than a predetermined number of times, then the user interface control part hides a first icon corresponding to the first application.

19. The multi-function apparatus of claim 17, wherein the multi-function apparatus is connected to a second multi-function apparatus via a network, and the usage history maintenance part maintains the usage history information based on global usage information received from the second multi-function apparatus.
